(19) United States
(12) Patent Application Publication
(10) Pub. No.: US 2018/0298857 A1
(43) Pub. Date: Oct. 18, 2018

(54) IMPELLER FOR FUEL PUMP

(71) Applicants: DENSO CORPORATION, Kariya-city, Aichi-pref. (JP); SUMITOMO BAKELITE CO., LTD., Tokyo (JP)

(72) Inventors: Takahiro OKUYA, Kariya-city (JP); Yuuji HIDAKA, Kariya-city (JP); Koji KOIZUMI, Tokyo (JP); Yusuke WATANABE, Tokyo (JP); Ryoichi IGAWA, Tokyo (JP)

(21) Appl. No.: 15/767,375

(22) PCT Filed: Oct. 26, 2016
(86) PCT No.: PCT/JP2016/081659

§ 371 Date: Apr. 11, 2018

(30) Foreign Application Priority Data
Oct. 29, 2015 (JP) 2015-212692

(51) Int. Cl. F02M 37/10; C08L 61/06; C08K 5/3477; C08K 7/14; C08K 3/36; C08K 3/34

(52) U.S. Cl. CPC F02M 37/10; C08L 61/06; C08K 3/346; C08K 7/14; C08K 3/36; C08K 5/3477

(57) ABSTRACT

An impeller for a fuel pump is molded by a molding material containing a phenolic resin and an inorganic filler. A content at a minimum spin-spin relaxation time is 70% or higher with respect to a whole when approximating a free induction decay curve, which is obtained by Solid Echo Method in a pulse NMR measurement at 90° C., with a sum of relaxation curves of three components. The content at the minimum spin-spin relaxation time corresponds to a content of a portion of the phenolic resin, which forms the impeller for the fuel pump, where a cross-linking reaction is caused. A swelling amount of the impeller due to a liquid containing a fuel and water decreases as a crosslink density of the phenolic resin increases. The swelling amount of the impeller in the present disclosure is smaller than the swelling amount of an impeller molded by PPS resin.

### CROSS REFERENCE TO RELATED APPLICATION

This application is based on and claims the benefit of priority from Japanese Patent Application No. 2015-212692 filed on Oct. 29, 2015. The entire disclosure of the application is incorporated herein by reference.

### TECHNICAL FIELD

The present disclosure relates to an impeller for a fuel pump.

### BACKGROUND ART

A fuel pump mounted to a vehicle or the like includes a housing and an impeller. The housing includes an inner wall defining a pump chamber into which a fuel flows. The impeller is made of resin and housed in the housing. The impeller is positioned such that a clearance having a specified dimension is secured between the inner wall and the impeller. The impeller may be swelled due to the fuel and water contained in the fuel, therefore a rotation of the impeller may be stopped when the impeller is swelled and comes in contact with the housing. Thus, the dimension of the clearance is set to prevent the impeller from coming in contact with the housing. However, when the dimension of the clearance is too large, an abnormality, e.g., an increase of an output loss of the fuel pump or an increase of a power consumption of the fuel pump, may occur because the fuel leaks through the clearance. Therefore, it is required to find a resin material to suppress a dimensional change of the impeller, which is mounted to the fuel pump, due to the fuel and the water contained in the fuel. The dimensional change will be referred to as a swelling amount hereinafter.

Patent Literature 1 discloses an impeller for a fuel pump that is formed of a resin material that contains a phenolic aralkyl resin, a phenolic resin, and a glass fiber. In Patent Literature 1, a difference in a solubility parameter (SP value) between the resin material and water is increased such that the swelling amount due to the water contained in the fuel is reduced. In addition, a mechanical strength of the impeller for the fuel pump is increased by adding the glass fiber to the resin material.

### PRIOR ART LITERATURES

### Patent Literature

Patent Literature 1: JP H8-93690 A

### SUMMARY OF INVENTION

However, the resin material disclosed by Patent Literature 1, which is used to mold the impeller, includes a modified phenolic resin, thereby including a small quantity of cross-linking points between molecules. As a result, whereas the impeller of Patent Literature 1 has a great resistance to water, the swelling amount due to the fuel may increase since a crosslink density decreases. The swelling amount due to the fuel and the water also may increase when an interface adhesion between resin and the glass fiber is weak.

Thus, PPS (Polyphenylene Sulfide) resin is used extensively as a resin material for molding the impeller mounted to the fuel pump. The swelling amount of an impeller molded by the PPS resin is smaller than the swelling amount of an impeller molded by a resin material containing a modified phenolic resin.

However, in view of reducing the output loss of the fuel pump and reducing the power consumption, it is required to find another resin material, which reduces the swelling amount due to the fuel and the water as compared to the PPS resin, to decrease the dimension of the clearance defined between the impeller and the housing.

The present disclosure addresses the above-described issues, thus it is an objective of the present disclosure to provide an impeller of which swelling amount due to a fuel and water can be small.

As one aspect of the present disclosure, an impeller for a fuel pump is molded by a molding material containing a phenolic resin and an inorganic filler. A content at a minimum spin-spin relaxation time is 70% or higher with respect to a whole when approximating a free induction decay curve, which is obtained by Solid Echo Method in a pulse NMR measurement at 90° C., with a sum of relaxation curves of three components.

A swelling amount of the impeller due to a liquid containing a fuel and water decreases as a crosslink density of the phenolic resin increases. The inventors of the present disclosure has focused on that the swelling amount of the impeller in the present disclosure is smaller than the swelling amount of an impeller molded by PPS resin. Then, the inventors of the present disclosure found that the swelling amount (%) of the impeller, of which content at the minimum spin-spin relaxation time is 70% or higher, is smaller than the swelling amount (%) of an impeller molded by PPS resin.

Thus, the present disclosure can provide an impeller for a fuel pump of which swelling amount due to the fuel and water is smaller than the swelling amount of the impeller molded by PPS resin.

### BRIEF DESCRIPTION OF DRAWINGS

The above and other objects, features and advantages of the present disclosure will become more apparent from the following detailed description made with reference to the accompanying drawings.

FIG. 1 is a view of a fuel pump having an impeller according to an embodiment of the present disclosure.

FIG. 2 is a planar view of an impeller according to an embodiment of the present disclosure.

FIG. 3 is a graph showing relationship between a content at a minimum spin-spin relaxation time and a swelling amount of the impeller after being soaked in fuel.

FIG. 4 is a graph showing a relationship between the minimum spin-spin relaxation time and the swelling amount of the impeller after being soaked in the fuel.

### DESCRIPTION OF EMBODIMENTS

An embodiment of the present disclosure will be described hereafter referring to drawings.

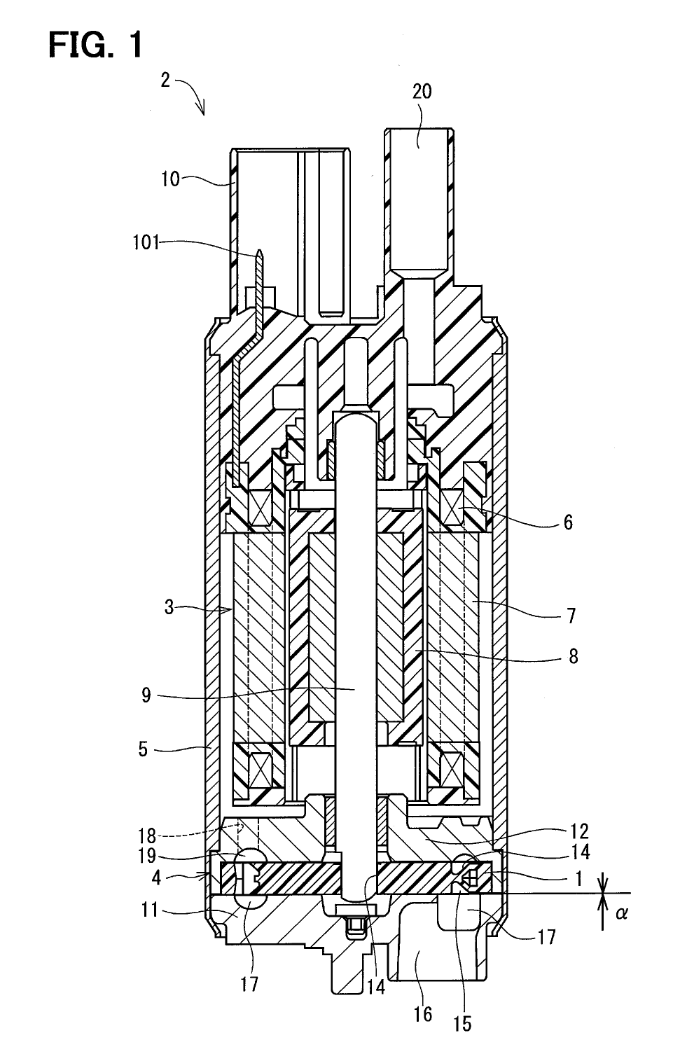

FIG. 1 shows a fuel pump 2 mounting an impeller 1 in the embodiment of the present disclosure.

(Configuration of Fuel Pump)

A configuration of the fuel pump 2 will be described hereafter. The fuel pump 2 includes a motor 3 and a pump 4. The motor 3 and the pump 4 are assembled integrally with each other by a pump case 5 having a tubular shape.

The motor 3 includes a stator 7, a rotor 8, and a shaft 9. A coil 6 is wound around the stator 7. The rotor 8 is rotatably positioned inside the stator 7. The shaft 9 rotates together with the rotor 8. The stator 7 generates a rotational magnetic field when electric power is applied to the coil 6, wound around the stator 7, from a terminal 101 of a connector 10. The rotor 8, in which an N pole and an S pole are alternately magnetized in a circumferential direction, rotates together with the shaft 9 around a rotational axis.

The pump 4 includes the impeller 1, a first pump housing 11, and a second pump housing 12.

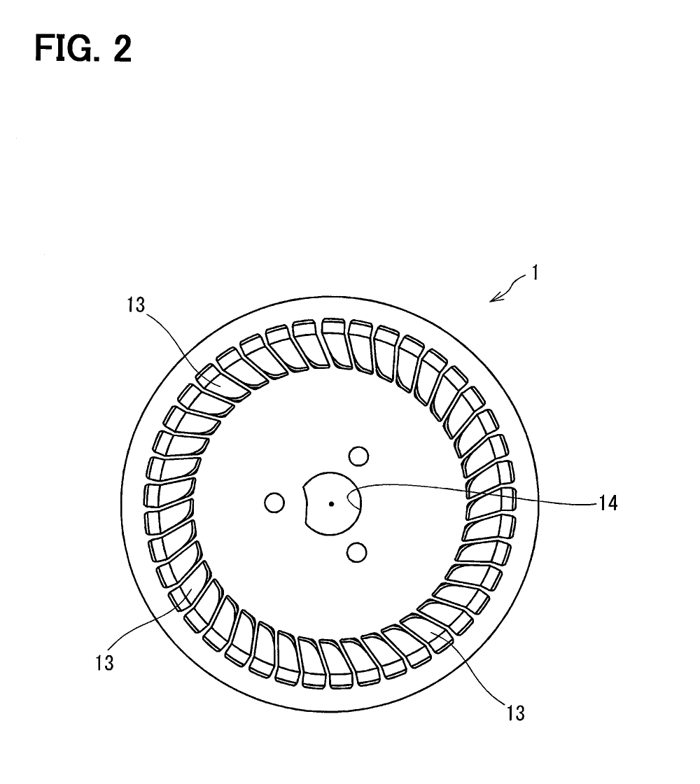

The impeller 1 is made of resin. As shown in FIG. 1 and FIG. 2, the impeller 1 has a discoid shape and includes blade grooves 13 that are arranged in the circumferential direction. The impeller 1 includes a center hole 14 into which the shaft 9 of the motor 3 is fitted. Therefore, the impeller 1 rotates together with the shaft 9. The impeller 1 is not limited to have the shape shown in FIG. 1 and FIG. 2 and may have various shapes.

The impeller 1 is housed in a pump chamber 15 that is defined between the first pump housing 11 and the second pump housing 12. The first pump housing 11 and the second pump housing 12 are made of, e.g., metal such as aluminum.

The first pump housing 11 includes a suction port 16. The first pump housing 11 further includes a first groove 17 formed in a surface of the first pump housing 11 facing the impeller 1. The first groove 17 extends in C-shape along the circumferential direction. The suction port 16 is in communication with the first groove 17.

The second pump housing 12 includes a communication hole 18 through which a side of the second pump housing 12 adjacent to the impeller 1 is in communication with a side of the second pump housing 12 adjacent to the motor 3. The second pump housing 12 further includes a second groove 19 formed in a surface of the second pump housing 12 facing the impeller 1. The second groove 19 extends in C-shape along the circumferential direction. The communication hole 18 is in communication with the second groove 19.

When the impeller 1 rotates together with the shaft 9 of the motor 3, a fuel in a fuel tank in which the fuel pump 2 is located is drawn into the pump chamber 15 from the suction port 16, flows through the first groove 17, and is compressed in the blade grooves 13 due to the rotation of the impeller 1. The fuel flows through the second groove 19, and is discharged to the motor 3 from the communication hole 18.

The fuel, which is discharged toward the motor 3 from the pump 4, flows through a clearance defined between the housing and the stator 7 and a clearance defined between the stator 7 and the rotor 8. Subsequently, the fuel is discharged from a discharge port 20 of the fuel pump 2 and flows to an internal combustion engine.

(Impeller for Fuel Pump)

The impeller 1 mounted to the fuel pump 2 will be described hereafter.

As shown in FIG. 1, the pump chamber 15 is defined between the first pump housing 11 and the second pump housing 12. In an aspect of the present disclosure, a clearance a having a specified dimension is defined between an inner wall defining the pump chamber 15 and the impeller 1. When the clearance a defined between the impeller 1 and the housing is large, the fuel may leak from the clearance a. As a result, an output loss of the fuel pump 2 may increase, or a power consumption of the fuel pump 2 may increase.

Here, the PPS resin may be employed as a resin material molding the impeller for the fuel pump in recent years. The swelling amount of the impeller, which is molded by the molding material in the compositions of the above-described examples, due to a liquid is smaller than the swelling amount of the impeller, which is molded by the PPS resin, due to the liquid. That is, the phenolic-resin molding material in the present disclosure is excellent in resistance to both the fuel and water.

In the present embodiment, the impeller contains a phenolic resin, which contains a novolac-type phenolic resin and hexamethylene tetramin, and an inorganic filler. Specifically, the impeller as a whole contains 20 to 55 mass % of the phenolic resin and 45 to 80 mass % of the inorganic filler. More preferably, the impeller as a whole contains 20 to 30 mass % of the phenolic resin and 70 to 80 mass % of the inorganic filler.

The swelling amount due to the fuel and water can be reduced when the impeller as a whole contains 55 mass % or less of the phenolic resin and 45 mass % or more of the inorganic filler.

In a case where the impeller is molded by an injection molding using a resin molding material, a deterioration of a flowability of the resin molding material is suppressed whereby the injection molding can be performed smoothly when the impeller as a whole contains 20 mass % or more of the phenolic resin and 80 mass % or less of the inorganic filler. Moreover, the impeller molded by the resin molding material is hardly damaged, therefore the impeller can be workable and assembled easily.

The phenolic resin contains the novolac-type phenolic resin and hexamethylene tetramin. Specifically, the phenolic resin contains 17 to 26 pts.mass of hexamethylene tetramin to 100 pts.mass of the novolac-type phenolic resin preferably. More preferably, the phenolic resin contains 20 to 25 pts.mass of hexamethylene tetramin to 100 pts.mass of the novolac-type phenolic resin.

When the phenolic resin contains 17 pts.mass or more of hexamethylene tetramin to 100 pts.mass of the novolac-type phenolic resin, a crosslinking density of the phenolic resin is increased. Therefore, the swelling amount due to the fuel and the water can be reduced.

When the phenolic resin contains 26 pts.mass or less of hexamethylene tetramin to 100 pts.mass of the novolac-type phenolic resin, it can be suppressed that an excess amount of hexamethylene tetramin is remained in the resin portion of the molding material. As a result, a generation of basic gas, which is generated due to hexamethylene tetramin, can be suppressed. Therefore, the impeller as a molded piece can be prevented from being swelled or damaged, when performing the injection molding with the resin molding material or when performing a baking after the injection molding.

The novolac-type phenolic resin contains 90 to 100 pts.mass of a non-modified novolac-type phenolic resin preferably. The non-modified novolac-type phenolic resin has a molecular structure expressed by the following chemical formula (1). n represents an integral number, which is one or more, in the chemical formula (1).

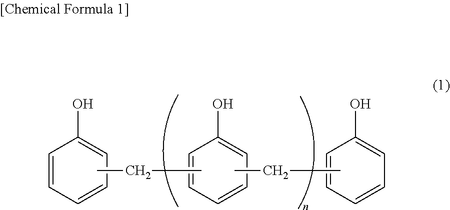

The non-modified novolac-type phenolic resin includes a larger quantity of points where a cross-linking reaction occurs as compared to a modified phenolic resin. Therefore, a content of the modified phenolic resin is 0 to 10 pts.mass and a content of the non-modified novolac-type phenolic resin is 90 to 100 pts.mass to 100 pts.mass of the novolac-type phenolic resin preferably. More preferably, the novolac-type phenolic resin contains 0 to 5 pts.mass of the modified phenolic resin and 95 to 100 pts.mass of the non-modified novolac-type phenolic resin. By increasing the content of the non-modified novolac-type phenolic resin, a crosslink density of the phenolic resin can be increased due to a chemical action of the non-modified novolac-type phenolic resin and hexamethylene tetramin. Thus, the swelling amount of the phenolic resin due to the fuel and the water can be reduced.

The inorganic filler may contain a glass fiber. When containing the glass fiber, a content of the glass fiber is 50 to 65 pts.mass to 100 pts.mass of the inorganic filler preferably. More preferably, the inorganic filler contains 53 to 63 pts.mass of the glass fiber. A mechanical strength of the impeller can be improved when the content of the glass fiber is 50 pts.mass or more.

In a case where the impeller is molded by the injection molding using the resin molding material, the deterioration of the flowability of the resin molding resin is suppressed whereby the injection molding can be performed smoothly when the content of the glass fiber is 65 pts.mass or less.

The inorganic filler may contain a clay. When containing the clay, a content of the clay is 25 to 35 pts.mass to 100 pts.mass of the inorganic filler. More preferably, the content of the clay is 30 to 34 pts.mass to 100 pts.mass of the inorganic filler. The clay can be blended into the phenolic resin well, thereby entering into the phenolic resin finely and suppressing the swelling of the impeller. Therefore, the swelling amount of the impeller due to the fuel and the water can be reduced when the content of the clay is 25 pts.mass or more.

In the case where the impeller is molded by the injection molding using the resin molding material, the deterioration of the flowability of the resin molding material is suppressed whereby the injection molding can be performed smoothly when the content of the clay is 35 pts.mass or less. In addition, a deterioration of the mechanical strength of the impeller can be suppressed when the content of the clay is 35 pts.mass or less.

The inorganic filler may contain a silica. When containing the silica, a content of the silica is 5 to 15 pts.mass to 100 pts.mass of the inorganic filler. More preferably, the content of the silica is 7 to 13 pts.mass to 100 pts.mass of the inorganic filler. In the case where the impeller is molded by the injection molding using the resin molding material, the deterioration of the flowability of the resin molding material is suppressed whereby the injection molding can be performed smoothly when the content of the silica is 5 pts.mass or more.

An effect of reducing the swelling amount of the impeller can be secured when the content of the silica is 15 pts.mass or lower.

The inorganic filler consists of a silicone compound without containing another compound such as calcium carbonate preferably. The silicone compound is reactive with a silane coupling agent. Therefore, an interface adhesion between the inorganic filler and the phenolic resin can be improved. As a result, the swelling amount of the impeller for a fuel pump due to the fuel and the water can be reduced. The silicone compound contains silicone. In the present embodiment, the silicone compound is, for example, silica, clay, talc, mica, a glass bead, a glass flake, or wollastonite.

The resin molding material forming the impeller may contain various fillers or various additive agents that are added to a well-known thermosetting resin molding material. For example, the resin molding material contains a release agent such as stearic acid or zinc stearate, an adhesion improving agent or a coupling agent that improves an adhesion between a filler and a thermosetting resin, a color pigment or a dye such as carbon black, or a solvent.

An example of a manufacturing method for manufacturing the resin molding material forming the impeller will be described hereafter. In a mixing step, the above-described contents of the raw materials are mixed uniformly. The kneading and melting step is performed by a device, such as a rolling device, a kneader, or a twin screw extruder, alone or by a combination of the rolling device and another mixing device. Subsequently, in a granulating step or a grinding step, the kneaded and melted material is granulated or grinded to be the resin molding material.

The molding material is suitable for the injection molding, however not limited to be used for the injection molding. For example, the molding material can be used for another method such as a transfer molding, a compression molding, and an injection compression molding.

The manufacturing method preferably includes a baking step in which the impeller, which is molded by the above-described method such as the injection molding, is baked for a specified time period at a specified temperature. By baking the impeller, the crosslink density of the phenolic resin can be further increased. The resin molding material is also baked in a baking step preferably. In the baking steps, the resin molding material and the impeller are baked for 50 to 70 minutes at 160 to 180° C. More preferably, the resin molding material and the impeller are baked for 55 to 65 minutes at 165 to 175° C.

Next, the resin molding material for molding the impeller mounted to the fuel pump in the present disclosure will be described referring to examples.

A granular molding material is provided by the following method. First, raw materials of a composition shown in Table 1 and Table 2 are kneaded by a heating roller at different rotational speeds such that the kneaded material is formed in a sheet shape. The kneaded material is cooled and grinded such that the granular molding material is provided. The kneading step by the heating roller is performed under a condition that the rotational speed of the heating roller is 20 rpm on a high-speed side and 14 rpm on a low-speed side, the specified temperature is 90° C. on the high-speed side and 20° C. on the low-speed side, and the specified time period for performing the kneading step is 5 to 10 minutes such that the molding material has a specified flowability.

The molding material used in the examples contains the following materials.

(1) novolac-type phenolic resin

(2) xylene-modified novolac-type phenolic resin

(3) hexamethylene tetramin

(4) glass fiber

(5) clay

(6) silica

(7) calcium carbonate

(8) silane coupling agent

Next, a molding method for molding a test piece, which is used for a characteristic evaluation, and a method of the characteristic evaluation are described hereafter.

(Test Piece)

A bending test piece is formed by a compression molding. In the compression molding, a temperature of a die is 175° C., and a setting time is 180 seconds. The bending test piece is 80 millimeters long, 10 millimeters wide, and 4 millimeters thick. The bending test piece is cut to have 2 millimeters long. Thus, the test piece having a cuboid shape, which is 2 millimeters long, 10 millimeters wide, and 4 millimeters thick, is provided. The test piece is baked for one hour at 170° C. in the baking step.

(Molded Piece)

An impeller shown in FIG. 2 is molded by a transfer molding. In the transfer molding, a temperature of a die is 175° C., and a setting time is 20 seconds. The molded piece (or impeller) is baked for one hour at 170° C. in the baking step.

More than one samples including the test pieces made of the molding material and impellers are provided by the above-described mixture and the above-described manufacturing method. Measurement results of the samples in the first through eighth examples are shown in the following Table 1, and measurement results of the samples in the ninth through fourteenth examples are shown in the following Table 2.

TABLE 1

| | | | 1^{st} Example | 2^{nd} Example | 3^{rd} Example | 4^{th} Example |
|---|---|---|---|---|---|---|
| Content of Phenolic Resin with respect to an entirety | | | 25 | 25 | 25 | 25 |
| of the Impeller (wt %) | | | | | | |
| Content of Hexamethylene Tetramin with respect to an | | | 17 | 20 | 23 | 25 |
| entirety of Novolac-Type Phenolic Resin (pts. mass) | | | | | | |
| Content of Xylene-Modified Novolac-Type Phenolic Resin | | | 0 | 0 | 0 | 0 |
| with respect to the entirety of Novolac-Type Phenolic | | | | | | |
| Resin (pts. mass) | | | | | | |
| Molding | Content | Non-Modified Novolac- | 21.4 | 20.8 | 20.4 | 20 |
| Material | (wt %) | Type Phenolic Resin | | | | |
| | | Xylene-Modified Novolac- | 0 | 0 | 0 | 0 |
| | | Type Phenolic Resin | | | | |
| | | Hexamethylene Tetramin | 3.6 | 4.2 | 4.6 | 5 |
| | | Glass Fiber | 42 | 42 | 42 | 42 |
| | | Clay | 23 | 23 | 23 | 23 |
| | | Silica | 7 | 7 | 7 | 7 |
| | | Calcium Carbonate | 0 | 0 | 0 | 0 |
| | | Silane Coupling Agent | 1 | 1 | 1 | 1 |
| | | Other | 2 | 2 | 2 | 2 |
| | Swelling Test | Rate of Change (%) | 0.12 | 0.05 | 0.04 | 0.04 |
| | M35 + Fuel D + | in Dimension of | | | | |
| | 0.5 wt % Water | the Test Piece | | | | |
| | 1000 hr | | | | | |
| Molded | Pulse NMR | Content (%) at Minimum | 70 | 73 | 74 | 75 |
| Piece | (Index of | Relaxation Time | | | | |
| | Crosslink Degree) | Minimum Relaxation Time (μS) | 8.4 | 8.3 | 8.1 | 8.2 |
| | Swelling Test | Rate of Change (%) | 0.55 | 0.33 | 0.2 | 0.2 |
| | M35 + Fuel D + | in Dimension of | | | | |
| | 0.5 wt % Water | the Molded Piece | | | | |
| | 5000 hr | in Thickness Direction | | | | |
| | Damage of | Presence of Damage | No | No | No | No |
| | Molded Piece | (Yes/No) | | | | |
| | | | 5^{th} Example | 6^{th} Example | 7^{th} Example | 8^{th} Example |
| Content of Phenolic Resin with respect to an entirety | | | 55 | 20 | 35 | 25 |
| of the Impeller (wt %) | | | | | | |
| Content of Hexamethylene Tetramin with respect to an | | | 23 | 23 | 23 | 23 |
| entirety of Novolac-Type Phenolic Resin (pts. mass) | | | | | | |
| Content of Xylene-Modified Novolac-Type Phenolic Resin | | | 0 | 0 | 0 | 10 |
| with respect to the entirety of Novolac-Type Phenolic | | | | | | |
| Resin (pts. mass) | | | | | | |
| Molding | Content | Non-Modified Novolac- | 44.9 | 16.3 | 28.6 | 18.4 |
| Material | (wt %) | Type Phenolic Resin | | | | |
| | | Xylene-Modified Novolac- | 0 | 0 | 0 | 2.0 |
| | | Type Phenolic Resin | | | | |
| | | Hexamethylene Tetramin | 10.1 | 3.7 | 6.4 | 4.6 |
| | | Glass Fiber | 24.6 | 44.8 | 36 | 42 |
| | | Clay | 13.4 | 24.7 | 20 | 23 |
| | | Silica | 4 | 7.5 | 6 | 7 |
| | | Calcium Carbonate | 0 | 0 | 0 | 0 |
| | | Silane Coupling Agent | 1 | 1 | 1 | 1 |
| | | Other | 2 | 2 | 2 | 2 |
| | Swelling Test | Rate of Change (%) | 0.12 | 0.04 | 0.06 | 0.07 |
| | M35 + Fuel D + | in Dimension of | | | | |
| | 0.5 wt % Water | the Test Piece | | | | |
| | 1000 hr | | | | | |
| Molded | Pulse NMR | Content (%) at Minimum | 74 | 74 | 74 | — |
| Piece | (Index of | Relaxation Time | | | | |
| | Crosslink Degree) | Minimum Relaxation Time (μS) | 8.1 | 8.1 | 8.1 | — |
| | Swelling Test | Rate of Change (%) | 0.6 | 0.2 | — | — |
| | M35 + Fuel D + | in Dimension of | | | | |
| | 0.5 wt % Water | the Molded Piece | | | | |
| | 5000 hr | in Thickness Direction | | | | |
| | Damage of | Presence of Damage | No | No | — | — |
| | Molded Piece | (Yes/No) | | | | |

TABLE 2

| | | | 9^{th} Example | 10^{th} Example | 11^{th} Example | 12^{th} Example |
|---|---|---|---|---|---|---|
| Content of Phenolic Resin with respect to an entirety | | | 25 | 25 | 15 | 60 |
| of the Impeller (wt %) | | | | | | |
| Content of Hexamethylene Tetramin with respect to an | | | 14 | 23 | 14 | 23 |
| entirety of Novolac-Type Phenolic Resin (pts. mass) | | | | | | |
| Content of Xylene-Modified Novolac-Type Phenolic Resin | | | 50 | 50 | 0 | 0 |
| with respect to the entirety of Novolac-Type Phenolic | | | | | | |
| Resin (pts. mass) | | | | | | |
| Molding | Content | Non-Modified Novolac- | 11 | 10.2 | 13.2 | 49.0 |
| Material | (wt %) | Type Phenolic Resin | | | | |
| | | Xylene-Modified Novolac- | 11 | 10.2 | 0 | 0 |
| | | Type Phenolic Resin | | | | |
| | | Hexamethylene Tetramin | 3 | 4.6 | 1.8 | 11.0 |
| | | Glass Fiber | 42 | 42 | 47.7 | 21.7 |
| | | Clay | 23 | 23 | 26.3 | 11.8 |
| | | Silica | 7 | 7 | 8 | 3.5 |
| | | Calcium Carbonate | 0 | 0 | 0 | 0 |
| | | Silane Coupling Agent | 1 | 1 | 1 | 1 |
| | | Other | 2 | 2 | 2 | 2 |
| | Swelling Test | Rate of Change (%) | 0.60 | 0.20 | 0.25 | 0.13 |
| | M35 + Fuel D + | in Dimension of | | | | |
| | 0.5 wt % Water | the Test Piece | | | | |
| | 1000 hr | | | | | |
| Molded | Pulse NMR | Content (%) at Minimum | 49 | 51 | 58 | 74 |
| Piece | (Index of | Relaxation Time | | | | |
| | Crosslink Degree) | Minimum Relaxation Time (μS) | 8.6 | 8.6 | 8.6 | 8.1 |
| | Swelling Test | Rate of Change (%) | 1 | 1 | 0.8 | 0.7 |
| | M35 + Fuel D + | in Dimension of | | | | |
| | 0.5 wt % Water | the Molded Piece | | | | |
| | 5000 hr | in Thickness Direction | | | | |
| | Damage of | Presence of Damage | No | No | Yes | No |
| | Molded Piece | (Yes/No) | | | | |

| | | | 13^{th} Example | 14^{th} Example | PPS |
|---|---|---|---|---|---|
| Content of Phenolic Resin with respect to an entirety | | | 25 | 35 | — |
| of the Impeller (wt %) | | | | | |
| Content of Hexamethylene Tetramin with respect to an | | | 13 | 23 | — |
| entirety of Novolac-Type | | | | | |
| Phenolic Resin (pts. mass) | | | | | |
| Content of Xylene-Modified Novolac-Type | | | 0 | 0 | — |
| Phenolic Resin with respect to the entirety | | | | | |
| of Novolac-Type Phenolic Resin (pts. mass) | | | | | |
| Molding | Content | Non-Modified Novolac- | 22.1 | 28.6 | — |
| Material | (wt %) | Type Phenolic Resin | | | |
| | | Xylene-Modified Novolac- | 0 | 0 | — |
| | | Type Phenolic Resin | | | |
| | | Hexamethylene Tetramin | 2.9 | 6.4 | — |
| | | Glass Fiber | 42 | 36 | — |
| | | Clay | 23 | 20 | — |
| | | Silica | 7 | 0 | — |
| | | Calcium Carbonate | 0 | 6 | — |
| | | Silane Coupling Agent | 1 | 1 | — |
| | | Other | 2 | 2 | — |
| | Swelling Test | Rate of Change (%) | 0.40 | 0.13 | — |
| | M35 + Fuel D + | in Dimension of | | | |
| | 0.5 wt % Water | the Test Piece | | | |
| | 1000 hr | | | | |
| Molded | Pulse NMR | Content (%) at Minimum | — | — | — |
| Piece | (Index of | Relaxation Time | | | |
| | Crosslink Degree) | Minimum Relaxation Time (μS) | — | — | — |
| | Swelling Test | Rate of Change (%) | — | — | 0.63 |
| | M35 + Fuel D + | in Dimension of | | | |
| | 0.5 wt % Water | the Molded Piece | | | |
| | 5000 hr | in Thickness Direction | | | |
| | Damage of | Presence of Damage | — | — | — |
| | Molded Piece | (Yes/No) | | | |

The test pieces molded by the molding material in compositions of the first through fourteenth examples are soaked in the liquid including the fuel D, which contains 35% methanol, and 0.5 wt % water for 1,000 hours. In Table 1 and Table 2, a rate of change (%) in dimension in a width direction of the test pieces, which is changed by being soaked in the liquid, is shown by a ratio (i.e., a dimensional change ratio) to a dimension of the test pieces before being soaked. The width direction is a direction in which the test piece is 10 millimeters wide. A test temperature at which the test pieces are soaked in the liquid is 80° C. The test temperature is set to 80° C. to correspond to a maximum limit of a temperature of a fuel of a vehicle.

As obvious from Table 1 and Table 2, the dimensional change ratios of the test pieces molded by the molding material in compositions of the first to eighth examples are smaller than the dimensional change ratios of the test pieces molded by the molding material in compositions of the ninth to fourteenth examples.

The impeller molded by the molding material in compositions of the first to fourteenth examples are soaked in the liquid including the fuel D, which contains 35% methanol, and 0.5 wt % water for 5,000 hours. In Table 1 and Table 2, a rate of change (%) in a thickness dimension in a thickness direction of the impeller as a whole, which is caused by the soaking, is shown by a ratio (i.e., a dimensional change ratio) to a thickness dimension of the impeller as a whole before being soaked.

As obvious from Table 1 and Table 2, the dimensional change ratios of the impeller, in the thickness direction, molded by the molding material in compositions of the first to sixth examples are smaller than the dimensional change ratios of the impeller, in the thickness direction, molded by the molding material in compositions of the ninth to fourteenth examples.

Here, the dimensional change ratio of the impeller, in the thickness direction, molded by PPS (R7-120NA manufactured by Solvay Corporation), is 0.63% under the same conditions. Therefore, the dimensional change ratio of the impeller, in the thickness direction, molded by the molding material in compositions of the first to sixth examples are smaller than the dimensional change ratio of the impeller, in the thickness direction, molded by PPS. On the other hand, the dimensional change ratio of the impeller, in the thickness direction, molded by the molding material in compositions of the ninth to twelfth examples are larger than the dimensional change ratio of the impeller, in the thickness direction, molded by PPS.

The molding material in compositions of the first to seventh and eleventh to fourteenth examples contains, as the novolac-type phenolic resin, only non-modified novolac-type phenolic resin. In the molding material in composition of eighth example contains, the novolac-type phenolic resin contains 10 mass % of the modified novolac-type phenolic resin and 90 mass % of the non-modified novolac-type phenolic resin. The dimensional change ratio of the test piece molded by the molding material in composition of the eighth example is 0.07%, i.e., is smaller than the dimensional change ratios of the test pieces molded by the molding material in compositions of the ninth to fourteenth examples.

In contrast, in the molding material in compositions of the ninth and tenth examples contain, the novolac-type phenolic resin contains 50 mass % of the modified novolac-type phenolic resin and 50 mass % of the non-modified novolac-type phenolic resin. That is, the content of the modified novolac-type phenolic resin is large in the ninth and tenth examples. Therefore, it is presumed that the modified novolac-type phenolic resin suppresses the cross-linking reactions between the novolac-type phenolic resin and hexamethylene tetramin, whereby the dimensional change ratios of the test pieces and the dimensional change ratios of the impeller increase in the ninth and tenth examples.

Next, a pulse NMR measurement is performed with the impellers molded by the molding material in compositions of the first to sixth, ninth to twelfth and fourteenth examples. In Table 1 and Table 2, a content at the minimum spin-spin relaxation time is shown as “a content at a minimum relaxation time”. The content at the minimum relaxation time is obtained by approximating a free induction decay curve, which is obtained by Solid Echo Method, with a sum of relaxation curves of three components. The more the content at the minimum relaxation time is, the higher the crosslink density is. The pulse NMR measurement is performed with a plurality of samples at 90° C.

The contents at the minimum relaxation time are 70% or higher in the first to seventh example. The contents of hexamethylene tetramin in the first, second, third and fourth examples increase in this order, therefore the contents at the minimum relaxation time increases in this order. In contrast, the contents at the minimum relaxation time are smaller than 70% in the ninth to eleventh examples.

In Table 1 and Table 2, a content at a spin-spin relaxation time with a content that makes the spin-spin relaxation time smallest is shown as “the minimum relaxation time”. That is, the shorter the minimum relaxation time is, the higher the crosslink density is. The minimum relaxation time is 8.5 microseconds or shorter in the first to seventh examples. In addition, the contents of hexamethylene tetramin of the first, second and third examples increase in this order, therefore the minimum relaxation time decreases in this order. The minimum relaxation time is longer than 8.5 microseconds in the ninth to eleventh examples.

Having considered the results of the pulse NMR measurements, it can be determined that the swelling amount is reduced as the crosslink density increases.

Regarding the twelfth example, the content at the minimum relaxation time is 70% or higher, and the minimum relaxation time is 8.5 microseconds or shorter. However, the impeller contains 60 mass % of the phenolic resin in the twelfth example. As a result, the dimensional change rate of the impeller molded by the molding material of the twelfth example is greater than the dimensional change rate of the impeller molded by the PPS resin.

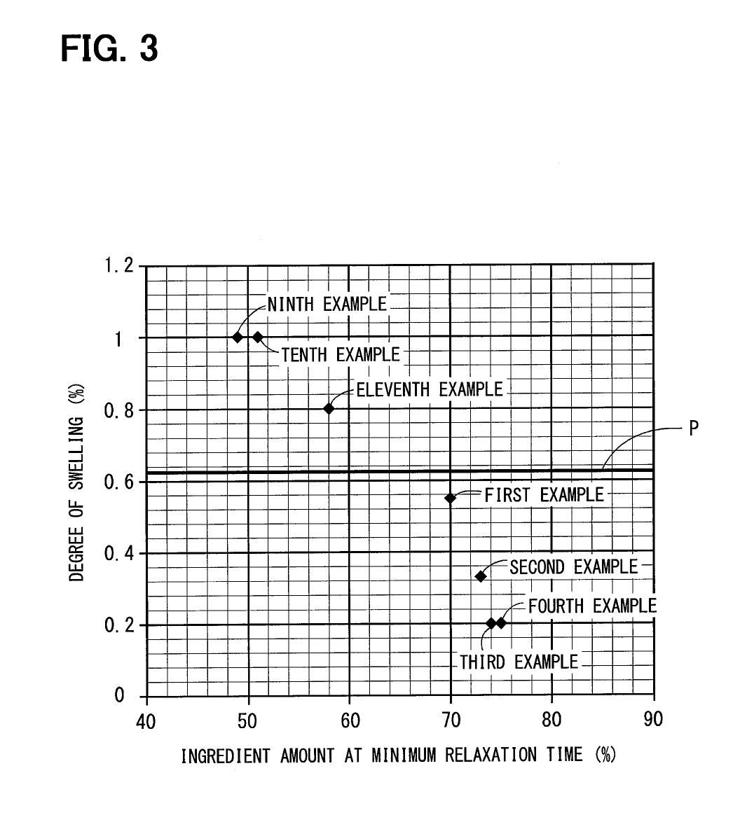

A graph shown in FIG. 3 relates to the impeller molded by the molding material in compositions of the first to fourth and ninth to eleventh examples shown in Table 1 and Table 2. The graph shows “the content at the minimum relaxation time at 90° C.” on the horizontal axis and “the dimensional change ratio (i.e., the swelling amount) of the impeller in the thickness direction” on the vertical axis. In the graph shown in FIG. 3, the swelling amount of the impeller molded by the PPS resin is shown with a solid line P.

The swelling amounts of the impellers molded by the molding material of the first to fourth examples each is smaller than the swelling amount of the impeller molded by the PPS resin. On the other hand, the swelling amounts of the impellers molded by the molding material of the ninth to eleventh examples each is larger than the swelling amount of the impeller molded by the PPS resin. The swelling amounts decrease in an order of the first example, the second example and the third example.

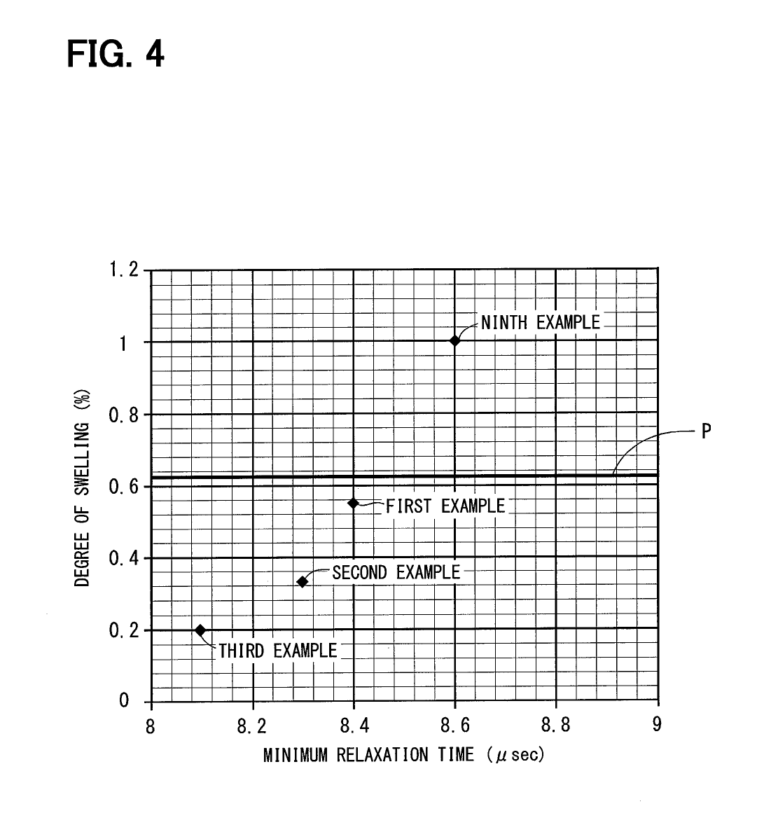

A graph shown in FIG. 4 relates to the impeller molded by the molding material in compositions of the first to third and ninth examples shown in Table 1 and Table 2. The graph shows “the content at the minimum relaxation time at 90° C.” on the horizontal axis and “the dimensional change ratio (i.e., the swelling amount) of the impeller in the thickness direction” on the vertical axis. In the graph shown in FIG. 4, the swelling amount of the impeller molded by the PPS resin is shown with a solid line P.

As shown in FIG. 4, the swelling amounts decrease in an order of the first example, the second example and the third example as the minimum relaxation times becomes shorter. On the other hand, regarding the ninth example, the minimum relaxation time is 8.6 milliseconds, and the swelling amount is larger than the PPS resin.

The molding material in the compositions of the examples shown in Table 1 and Table 2 will be described in detail hereafter.

In the sixth example, the impeller as a whole contains 20 mass % of the phenolic resin. In the sixth example, a damage is not found in the impeller molded by the molding material of the sixth example. In the fifth example, the impeller as a whole contains 55 mass % of the phenolic resin. In the fifth example, the dimensional change ratio of the impeller in the thickness direction is 0.6%, i.e., is smaller than the dimensional change ratio of the impeller, in the thickness direction, molded by the PPS resin.

In contrast, the impeller as a whole contains 60 mass % or the phenolic resin in the twelfth example. In other words, the molding material contains a large volume of the phenolic resin, which is swelled possibly, in the twelfth example. That is presumed to be the reason why the dimensional change ratio of the impeller, in the thickness direction, molded by the molding material of the twelfth embodiment is greater than the dimensional change ratio of the impeller, in the thickness direction, molded by the PPS resin.

In the first example, the molding material contains 17 pts.mass of hexamethylene tetramin to 100 pts.mass of the novolac-type phenolic resin. In other words, the content of hexamethylene tetramin in the first example is smaller than that in the second to eighth examples. Regarding the impeller molded by the molding material of the first embodiment, the content at the minimum relaxation time is 70%, and the dimensional change ratio in the thickness direction is 0.55%, i.e., is smaller than the dimensional change ratio of the impeller, in the thickness direction, molded by the PPS resin.

In contrast, the molding material of the thirteenth embodiment contains a smaller content of hexamethylene tetramin as compared to the molding material of the first embodiment. Thus, it is presumed that the cross-linking reaction in the phenolic resin is not promoted, therefore the swelling amount increases.

In the third example, the molding material contains 23 pts.mass of hexamethylene tetramin to 100 pts.mass of the novolac-type phenolic resin. In the fourth example, the molding material contains 25 pts.mass of hexamethylene tetramin to 100 pts.mass of the novolac-type phenolic resin. The dimensional change ratios of the impellers, in the thickness direction, molded by the molding material in compositions of the third and fourth examples each is 0.2%. Having considering the result, it is presumed that the cross-linking reaction is not promoted in the novolac-type phenolic resin even when the content of hexamethylene tetramin increases above a specified content.

In the molding material in the compositions of the first to eighth examples, the inorganic filler consists of a silicone compound such as glass fiber, clay, or silica. The molding material of the fourteenth example is different from that of the seventh example in a point that the molding material contains calcium carbonate instead of silica. Therefore, the dimensional change ratio of the test piece molded by the molding material of the fourteenth example is 0.13%, i.e., is greater than the dimensional change ratio (0.06%) of the test piece molded by the molding material of the seventh example. Having considered the results, it is presumed that the silane coupling agent does not have an interface-adhesion effect on the test piece molded by the molding material of the fourteenth example, therefore the swelling amount increases.

According to the impeller for a fuel pump in the present disclosure, the content at the minimum spin-spin relaxation time is 70% or higher with respect to a whole when approximating a free induction decay curve, which is obtained by Solid Echo Method in the pulse NMR measurement at 90° C., with a sum of relaxation curves of three components. By the pulse NMR measurement, the swelling amount of the impeller, molded by the molded material in the compositions of the above-described examples, due to the liquid containing the fuel and water can be smaller than the swelling amount of the impeller molded by the PPS resin.

While the present disclosure has been described with reference to preferred embodiments thereof, it is to be understood that the disclosure is not limited to the preferred embodiments and constructions. The present disclosure is intended to cover various modification and equivalent arrangements within a scope of the present disclosure. It should be understood that structures described in the above-described embodiments are preferred structures, and the present disclosure is not limited to have the preferred structures. The scope of the present disclosure includes all modifications that are equivalent to descriptions of the present disclosure or that are made within the scope of the present disclosure.

1. An impeller for a fuel pump, the impeller that is molded by a molding material containing a phenolic resin and an inorganic filler, wherein
a content at a minimum spin-spin relaxation time is 70% or higher with respect to a whole when approximating a free induction decay curve, which is obtained by Solid Echo Method in a pulse NMR measurement at 90° C., with a sum of relaxation curves of three components.

2. The impeller for a fuel pump according to claim 1, wherein the minimum spin-spin relaxation time is 8.5 microseconds or shorter.

3. The impeller for a fuel pump according to claim 1 or 2, wherein
the phenolic resin contains novolac-type phenolic resin and hexamethylene tetramin,
a content of the phenolic resin is 20 to 55 mass %, and
a content of the inorganic filler is 45 to 80 mass %.

4. The impeller for a fuel pump according to claim 3, wherein
the phenolic resin contains 17 to 26 pts.mass of the hexamethylene tetramin to 100 pts.mass of the novolac-type phenolic resin.

5. The impeller for a fuel pump according to claim 3 or 1, wherein
the novolac-type phenolic resin contains a non-modified novolac-type phenolic resin that has a molecular structure expressed by a chemical formula (1),
n represents an integral number, which is one or more, in the chemical formula, and
a content of the non-modified novolac-type phenolic resin is 90 to 100 pts.mass to 100 pts.mass of the novolac-type phenolic resin.

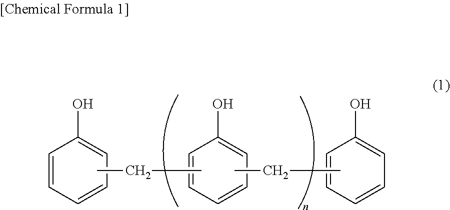

6. The impeller for a fuel pump according to claim 1, wherein
the inorganic filler contains a glass fiber, and
a content of the glass fiber is 50 to 60 pts.mass to 100 pts.mass of the inorganic filler.

7. The impeller for a fuel pump according to claim 1, wherein
the inorganic filler contains a clay, and
a content of the clay is 25 to 35 pts.mass to 100 pts.mass of the inorganic filler.

8. The impeller for a fuel pump according to claim 1, wherein
the inorganic filler contains a silica, and
a content of the silica is 5 to 15 pts.mass to 100 pts.mass of the inorganic filler.

9. The impeller for a fuel pump according to claim 1, wherein the inorganic filler is consist of a silicone compound.

10. The impeller for a fuel pump according to claim 1, wherein
the inorganic filler contains a glass fiber and a clay,
a content of the glass fiber is 50 to 60 pts.mass to 100 pts.mass of the inorganic filler, and
a content of the clay is 25 to 35 pts.mass to 100 pts.mass of the inorganic filler.

11. The impeller for a fuel pump according to claim 4, wherein
the phenolic resin contains 20 to 25 pts.mass of the hexamethylene tetramin to 100 pts.mass of the novolac-type phenolic resin.
